(19) United States
(12) Patent Application Publication
(10) Pub. No.: US 2003/0065236 A1
(43) Pub. Date: Apr. 3, 2003

(54) Process for the low-corrosion and low-emission co-incineration of highly halogenated wastes in waste incineration plants

(76) Inventors: Bernhard Vosteen, Koln (DE); Joachim Beyer, Kurten (DE); Peter Krippner, Leverkusen (DE)

Correspondence Address: BAYER CORPORATION, PATENT DEPARTMENT, 100 BAYER ROAD, PITTSBURGH, PA, 15205, US

(21) Appl. No.: 10/180,358

(22) Filed: Jun. 26, 2002

(30) Foreign Application Priority Data
Sep. 29, 2001 (DE) 10131464.7

(51) Int. Cl. A62D 3/00; B09B 3/00; G05D 7/00

(52) U.S. Cl. 588/208; 422/184.1; 422/105; 422/110

(57) ABSTRACT

The invention relates to a process and an apparatus for the low-corrosion and low-emission co-incineration of highly halogenated wastes, in particular liquid waste, in waste incineration plants having at least one combustion chamber, a waste-heat boiler, a multistage flue gas scrubber comprising a single-stage or multistage acidic scrubber and an alkaline scrubber, in which sulfur or a corresponding sulfur carrier is added under control to the primary and/or secondary combustion chamber. The amount of sulfur is controlled substantially in proportion to the current halogen loading originating from the waste in the boiler flue gas.

### BACKGROUND OF THE INVENTION

The invention relates to the low-corrosion and low-emission co-incineration of highly halogenated wastes, preferably liquid wastes, in a waste incineration plant. Unwanted free halogens, for example, free chlorine, Cl₂, free bromine, Br₂, and/or free iodine, I₂, already form in parts in the furnace and then, to an increased extent, at the start of flue gas cooling in the following boiler. The temperature-dependent, kinetically limited reformation of free halogens from the corresponding hydrogen halides proceeds according to the Deacon reaction which, however, is fortunately greatly restricted. By means of controlled addition (that is to say matched to the respective total halogen loading) of sulfur to the combustion chamber of the waste incineration plant and the SO₂ formed therefrom due to combustion, substantial suppression of these free halogens is still possible in the boiler, that is to say on the flue gas pathway up to the end of the boiler.

A waste incineration plant is described, for example, in H. W. Fabian et al, “How Bayer incinerates wastes”, Hydrocarbon Processing, April 1979, page 183. Typical waste incineration plants comprise a primary combustion chamber (for example, rotary kiln), a secondary combustion chamber (afterburning chamber), and a waste heat boiler, and also include an electrostatic or filtering dust separator, a flue gas scrubber having, for example, single-stage or multistage acidic scrubbing (quench and, for example, acid rotary deduster-scrubber), and alkaline scrubbing (for example alkaline rotary deduster-scrubber), and also, if appropriate, having a demister and, for example, a condensation electrostatic precipitator.

In the combustion of halogenated wastes, as a result of hydrolysis, first predominantly hydrogen halides, such as HCl, and to a lesser extent also free halogens and traces of initially unbound halogen free radicals and halogen atoms, are formed in the combustion chamber. In the course of flue gas cooling, the latter recombine to form free halogens. In addition, especially in the presence of metal-oxide-rich fly dusts as catalysts of the Deacon reaction (4 HX+O₂⇄2 X₂+2H₂O where X is Cl, Br, or 1), free halogens, such as chlorine, Cl₂, are increasingly formed from the hydrogen halides. The extent of this reformation of free halogens according to the catalyzed Deacon reaction is co-dependent on the type and amount of boiler fly dusts.

Free halogens are unwanted for many reasons. First, for example, in contrast to the hydrogen halides, free halogens are insoluble in the acidic scrubber area and can be scrubbed out by chemisorption using, for example, sodium hydroxide solution (NaOH), only as sodium halide in the alkaline scrubber and, in equal parts, as sodium hypohalite. Second, the hypohalite concentration in the alkaline scrubber water must be kept low, using a sufficient supply of reducing agents (that is to say must be reduced to the stable sodium halide), for example, by hydrogen sulfide or thiosulfate, in order to avoid free halogen emissions on the clean gas side. If there is an insufficient reducing agent supply, there is the risk that the clean gas, downstream of the flue gas scrubber, will not comply with legally prescribed limiting values. Third, relatively high concentrations of free halogens in the boiler flue gas can cause corrosion in the boiler and also in other parts of the plant. Fourth, free halogens promote de-novo synthesis of dioxins and furans in the middle and downstream boiler area and, if appropriate, also in an electrostatic or filtering dust separator installed directly downstream of the boiler.

By suppressing free chlorine and/or other free halogens by using SO₂, the above-described unwanted effects and the de-novo formation of dioxins and furans (see H. W. Fabian et al, “How Bayer incinerates wastes”, Hydrocarbon Processing, April 1979, page 183) can be suppressed or at least greatly limited. See R. D. Griffin, “A New Theory of Dioxin Formation in Municipal Solid Waste Combustion”, Chemosphere, Vol.15 (1986), pages 1987-1990; and T. Geiger et al, “Einfluss des Schwefels auf die Dioxin- und Furanbildung bei der Klärschlamm-verbrennung” [Effect of sulfur on dioxin and furan formation in sludge incineration], VGB Kraftwerkstechnik 72(1992), pages 159-165; and P. Samaras et al, “PCDD/F Prevention by Novel Inhibitors: Addition of Inorganic S- and N-Compounds in the Fuel before Combustion”, Environ. Sci. Technol. 34 (2000), pages 5092-5096.

It is known that the free halogens still react with SO₂ in the boiler. Free chlorine, for example, reacts with SO₂ and steam back to hydrogen chloride, with formation of SO₃. See, for example, H. W. Fabian et al, “How Bayer incinerates wastes”, Hydrocarbon Processing, April 1979, page 183, with respect to Cl₂ suppression. Free bromine also reacts with SO₂. See D. A. Oberacker et al, “Incinerating the Pesticide Ethylene Dibromide (EDB: a Field-Scale Trial Burn Evaluation Environmental Performance”, Report EPA/600/D-88/198, Order No. PB89-118243 (1988). However, it is thought that this reaction between Br₂ and SO₂ does not lead directly to hydrogen bromide, but, in the boiler, leads firstly to SO₂Br₂ (sulfuryl bromide), which is then hydrolyzed in the acidic scrubber to form HBr and SO₄²⁻. In the incineration of highly halogenated wastes, it is not precisely known to date what proportions of the respective halogen loading in the boiler flue gas occur temporarily as free halogens X₂ (for example, as Cl₂ and/or Br₂). It is only known that, in accordance with the temperature dependence of the thermodynamic equilibria of the respective Deacon reaction, in the case of bromine and iodine there is a tendency for a much higher proportion of free halogens to be reformed than in the case of chlorine.

According to H. W. Fabian et al, “How Bayer incinerates wastes”, Hydrocarbon Processing, April 1979, page 183, the ratio of sulfur and chlorine in the burnt waste assortment should be such as to give a “molar ratio of sulfur/chlorine >1”. However, it was not known more precisely how much “chlorine” (free chlorine is meant) as a molar reference is present in the interim in changing total chlorine loadings in boiler flue gas.

Corresponding uncertainties existed and still exist with the other free halogens, too, particularly Br₂ and I₂.

It is also known that the free halogens (which are virtually insoluble in the strongly acidic scrubber area and can therefore not be removed by scrubbing), for example, Cl₂ and/or Br₂ together with the residual SO₂ (also virtually insoluble in the strongly acidic scrubber area), are not removed from the dirty boiler gas before the quench until during the subsequent joint chemisorption in the alkaline scrubber and are then also bound in a stable form as, for example, NaX, more precisely by reduction of the unstable hypohalite NaOX, first co-formed in addition to NaX during the chemisorption, to give the stable NaX. See EP 406,710.

Finally, it is also known that this reduction of NaOX to the stable NaX cannot proceed not only via the hydrogen sulfide, which forms internally in the process from the residual SO₂ that is also chemiabsorbed in the alkaline scrubber, but also via a reducing agent added externally to the alkaline scrubber, for example, thiosulfate (Na₂S₂O₃.5H₂O). See W. Oppenheimer et al, “Thermische Entsorgung von Produktionsabfällen” [Thermal disposal of production wastes], Entsorgungs-Praxis 6 (2000), pages 29-33.

The measures for waste incineration plants known to date from the prior art are not sufficient for reliable and also inexpensive suppression and/or binding of the free halogens formed during the incineration of highly halogenated wastes. As a result of deliberate changes in the waste assortment and operational fluctuations, total halogen loadings frequently vary. Nevertheless, there is a lack of suitable measures for addition of operating media that is always optimally adapted to the current total halogen loading, and a corresponding cost-optimized suppression of free halogens, particularly under high total halogen loadings.

It is an object of the invention, therefore, to find a process for the low-corrosion and low-emission co-incineration of highly halogenated wastes in waste incineration plants with minimum consumption of operating media and minimum residue production.

### SUMMARY OF THE INVENTION

The object according to the invention is achieved by a process and an apparatus for the low-corrosion and low-emission co-incineration of highly halogenated liquid wastes in waste incineration plants having at least one combustion chamber, a waste-heat boiler, a flue gas scrubber (for example, comprising a single-stage or multistage acidic scrubber and an alkaline scrubber), in which solid or liquid sulfur or corresponding sulfur carriers (for example, waste sulfuric acid, in addition to other sulfur-containing wastes) are added in a controlled manner to the combustion chamber. The addition of sulfur or corresponding sulfur carriers is controlled, essentially, in proportion to the current total halogen loading (for example the total chlorine and/or bromine loading) in the flue gas.

### BRIEF DESCRIPTION OF THE DRAWINGS

FIG. 1 shows a diagram of a waste incineration plant (special waste incineration plant VA1 in the Bayer Leverkusen-Burrig disposal center).

FIG. 2 shows the closed sulfur balance covering furnace, boiler, and acidic scrubber for the incineration of highly chlorinated waste.

FIG. 3 shows the chlorine balance (HCl discharge with the waste water of the acidic scrubber and NaCl discharge with the waste water of the alkaline scrubber).

FIG. 4 shows a primary control circuit.

FIG. 5 shows a sulfur addition ramp for the incineration of highly chlorinated waste.

FIG. 6 shows determination of a point on the linear sulfur addition ramp.

FIG. 7 shows an abrupt increase in total halogen loading in the flue gas and in contrast delayed rise in halide loading in the acidic waste water.

FIG. 8 shows an example of Cl₂ breakthrough in the event of abrupt increase in loading with sole use of the primary control circuit.

FIG. 9 shows an extended control circuit with feed-forward control.

FIG. 10 shows correction of apparent Cl₂ reading due to NOx cross sensitivity of a Cl₂ measuring instrument in the clean gas upstream of SCR.

FIG. 11 shows imposed chlorine loading jumps for the experiment shown in the following FIG. 12, using the extended control circuit.

FIG. 12 shows that when the extended control circuit with feed-forward control is used, despite the abrupt rise in loading, no Cl₂ break-through is observed.

FIG. 13 shows a closed sulfur balance covering furnace, boiler, and acidic scrubber for the incineration of highly brominated waste.

FIG. 14 shows a bromine balance (HBr discharge with the acidic scrubber waste water and NaBr discharge with the alkaline scrubber waste water).

FIG. 15 shows a comparison in conductivity of aqueous HCl and HBr solutions.

FIG. 16 shows back-conversion of Cl₂ to HCl on clean gas passage through the downstream SCR.

### DETAILED DESCRIPTION OF THE INVENTION

The sulfur can be added directly to the primary or secondary combustion chamber in the form of solid sulfur, liquid sulfur, or other sulfur carriers, for example, waste sulfuric acid.

Solid sulfur is preferably added in pelleted or granulated form. This form of addition has the advantage that the pelleted or granulated solid sulfur (for example, sulfur granules) can be safely handled and is easily metered, better than, for example, pulverulent flowers of sulfur. The sulfur granules are preferably added to the primary combustion chamber by pneumatic feed. Sulfur granules should be fed using a controllable metering and transport system such as a metering screw or vibrating chute. Preference is given to a controllable-speed metering screw having subsequent injector and pneumatic feed pipe to the combustion chamber, preferably to the top of the rotary kiln (“blasting in the sulfur granules”). Waste sulfuric acid is added to the primary or secondary combustion chamber using a controllable metering pump via atomizer nozzles or corresponding jet assemblies.

Other sulfur-containing wastes, and also the solid or liquid sulfur or sulfur carrier added in a controlled manner, burn in the primary and/or secondary combustion chamber, forming SO₂.

The addition of sulfur or other sulfur carriers to the combustion chamber is according to the invention, starting from the current flue gas total halogen loading, to be controlled in such a manner that a computed theoretical SO₂ content in the flue gas upstream of the boiler or, alternatively, a corresponding theoretical residual SO₂ content in the dirty boiler gas upstream of the quench is maintained continuously.

The sulfur or sulfur carrier added in a controlled manner is intended to increase the SO₂ supply in the boiler flue gas sufficiently, but not excessively. The SO₂ required not only to suppress free halogens in the boiler but also for the hypochlorite reduction in the subsequent alkaline scrubber increases with the total halogen loading, that is to say the required SO₂ content in the flue gas upstream of the boiler (downstream of the secondary combustion chamber) or the corresponding residual SO₂ content in the dirty boiler gas downstream of the boiler (upstream of the quench) must be increased with the total halogen loading. The proportion of free halogens in the total halogen loading in the case of bromine or even iodine is considerably greater than for chlorine and thus also the specific sulfur requirement, that is to say that based on the total halogen loading in the flue gas.

It has been determined in operational studies from “chlorine and sulfur balances” that, in the boiler flue gas of a typical waste incineration plant (operated with oxygen contents of, for example, 11% by volume dry basis of O₂ and steam contents of, for example, 10 to 30% by volume dry basis of H₂O), from hydrogen chloride, via the chlorine-Deacon reaction (4 HCl+O₂⇄2 Cl₂+2 H₂O), with advancing flue gas cooling, approximately 4% of the total chlorine loading is reformed as free chlorine, Cl₂. Of this 4% of reformed free chlorine, about 75% (corresponding to about 3% of the total chlorine loading) is reconverted to HCl, together with SO₂ and steam, while still in the boiler, via the Griffin reaction Cl₂+SO₂+H₂O→2 HCl+SO₃. If the sulfur supply is sufficient, therefore, approximately 99% of the chlorine loading in total passes as water-soluble HCl directly into the waste water of the acidic scrubber. Accordingly, only approximately 1% of the chlorine loading in total passes as free chlorine, Cl₂, into the waste water of the subsequent alkaline scrubber. There, the free chlorine, CO₂, is chemisorbed at the same time as the SO₂ and, if the residual SO₂ supply from the dirty boiler gas upstream of the quench is sufficient, reduced to sodium chloride.

From operational studies and corresponding balances for the case of bromine, it has been found that the reformed fraction of free bromine, Br₂, in the boiler flue gas of a waste incineration plant (operated with oxygen contents of, for example, 11% by volume dry basis of O₂ and steam contents of, for example, 10 to 30% by volume dry basis of H₂O) is much greater than for chlorine. The Br₂ fraction here was not at only 4% of the total halogen loading (see chlorine) but was between 40% at relatively low total bromine loadings and 65% at very high total bromine loadings.

Such balances in the case of bromine verify that free bromine, in the presence of sufficient SO₂ supply still in the boiler, is suppressed by >90%, probably due to the formation of sulfuryl bromide SO₂Br₂ according to the reaction equation SO₂+Br₂⇄SO₂Br₂. Our operational studies with relatively small to very high total bromine loadings found in any case that, as was not known to date, a reaction product is already formed in the boiler, probably this not currently directly detectable SO₂Br₂ which, demonstrably, hydrolyses in the acidic scrubber region to form HBr and SO₄²⁻. If there is sufficient SO₂ supply in the flue gas, for bromine also, approximately 99% of the total halogen loading is recovered as bromide, HBr, in the waste water of the acidic scrubber. Here also, similarly to chlorine, only approximately 1% of the total halogen loading passes as Br₂ into the water from the alkaline scrubber, where it is chemisorbed and, if there is sufficient residual SO₂ supply, reduced to stable NaBr.

The halide loading of the acidic waste water is therefore a good measure of the total halogen loading of the boiler flue gas, at least in the steady operating state, since at a constant charging rate, the total halogen loading of the boiler flue gas is approximately 99% identical to the halide loading of the waste water of the acidic scrubber not only in the case of chlorine but also in the case of bromine.

In the nonsteady operating state, in contrast (that is to say in the event of rapid changes in loading), the halide loading discharged at a particular time with the acidic waste water from the quench follows the current total halogen loading of the boiler flue gas only slowly, that is to say it does not appear with the quench waste water until later, more precisely delayed in time by the mean residence time of the wash water in the bottom phase of the acidic scrubber (order of magnitude of, for example 45 min).

The halide concentration in the acidic waste water is obtained, for example, from conductivity measurement. It is known that the electrical conductivity of aqueous halide solutions is highly temperature-dependent. Therefore, temperature measurement is integrated into the conductivity measurement for temperature compensation. The associated halide loading in the acidic waste water is then given by multiplying the halide concentration by the acidic waste water volumetric flow rate measured, for example, by means of an inductive flow meter.

As an alternative to the indirect determination described of the total halogen loading of flue gas as halide loading in the acidic waste water, the current total halogen loading of flue gas could also be determined directly, but in a comparatively complex manner, from the HX and X₂ contents in the dirty boiler gas and from the flue gas volumetric flow rate or a parameter proportional to the flue gas volumetric flow rate, such as the boiler steam output. For this purpose the HX and X₂ contents in the dirty boiler gas upstream of the quench would have to be measured, for example, using instruments based on near infrared spectrometry.

In order to cover the sulfur requirement continuously satisfactorily, starting from the current total halogen loading, but not to supply unnecessary sulfur, for the mass flow rate of sulfur to be added, first a “primary control circuit using an operationally predetermined sulfur addition ramp” is advisable. In this primary control circuit, the continuously measured residual SO₂ content in the dirty boiler gas upstream of the quench (downstream of the boiler) serves as “acquired control variable”, as discussed below.

Intermediate free halogens are not always completely suppressed in the boiler, as explained, more precisely, for example, in the case of chlorine only approximately 75% suppressed. The residual approximately 25% free chlorine passes into the alkaline scrubber. Provided that no other reducing agents are added there from the outside, a certain residual SO₂ content is always still in the dirty boiler gas upstream of the quench (downstream of the boiler) to provide sufficient bisulfide as reducing agent internally to the process in the alkaline scrubber.

The bisulfide which is formed internally in the process in the alkaline scrubber from the residual SO₂ of the dirty boiler gas is known not to be stable to oxidation, that is to say it serves there not only for the wanted reduction of hypochlorite (NaOCl), but also reacts at the same time with dissolved oxygen. The residual SO₂ content required in the dirty boiler gas upstream of the quench in the case of chlorine is therefore considerably higher, from the stoichiometric point of view, than that which would correspond to the residual chlorine loading chemisorbed in the alkaline scrubber. These findings lead—for the set-point of the residual SO₂ content in the dirty boiler gas upstream of the quench, depending on the current total chlorine loading (kg Clₜₒₜ/h) and, relating this loading to the dry flue gas flowrate, on the corresponding Clₜₒₜ concentration in the dirty boiler gas (mg Clₜₒₜ/m³ (STP)_{dry})—to what is termed a plant-specific “sulfur addition ramp” to be predetermined under operational conditions.

The sulfur addition ramp can be determined under operational conditions, for example, for chlorine, in the following way: an “operational test at a preselected high total chlorine loading” required for this is carried out and is started with initially greatly excessive sulfur supply and accordingly a greatly excessive residual SO₂ content in the dirty boiler gas upstream of the quench (downstream of the boiler). Therefore, in the alkaline scrubber, there is first also a considerable bisulfide supply. In contrast, there is no hypochlorite in the alkaline scrubber and, correspondingly, at first no free chlorine is detectable in the clean gas downstream of the alkaline scrubber. The sulfur supply is then decreased stepwise to the point that free chlorine is detectable on the clean gas side. The preselected total chlorine loading or the corresponding preselected Clₜₒₜ concentration in the dirty boiler gas (mg Clₜₒₜ/m³ (STP)_{dry}), first, and the resultant residual SO₂ content in the dirty boiler gas, second, at which free chlorine becomes noticeably detectable, form one point on the sulfur addition ramp.

In itself, this point is already sufficient to establish a sulfur addition ramp as the relationship between the total chlorine loading, with Clₜₒₜ concentration in the flue gas on the one hand and the required minimum value of the continuously measured residual SO₂ content in the dirty boiler gas upstream of the quench (downstream of the boiler) on the other, since the sulfur addition ramp is the straight line through this one measured point and the origin of the coordinates. The straight line determined in this way thus indicates with sufficient accuracy, for a wide chlorine loading range, the set-point residual SO₂ content in the dirty boiler gas upstream of the quench (downstream of the boiler) that must be maintained for differing total chlorine loadings, so that in the alkaline scrubber there is always sufficient bisulfide and the hypochlorite reduction that is wanted there takes place, so that virtually no free chlorine, Cl₂, can be found any more in the clean gas downstream of the alkaline scrubber or so that only a minimum Cl₂ concentration in the clean gas that is below a predetermined limiting value can be found.

A corresponding plant-specific sulfur addition ramp for the addition of sulfur can also be determined in the case of bromine or iodine.

As a result of the “SO₂ consumption” in the boiler, the SO₂ content in the flue gas upstream of the boiler (which is not measured operationally) must be significantly higher than the residual SO₂ content in the dirty boiler gas upstream of the quench (downstream of the boiler) (which is measured continuously operationally). The difference (that is to say the halogen-specific SO₂ consumption in the boiler) can be calculated: for chlorine, for example, the current total chlorine loading (or the corresponding chloride loading in acidic waste water) must be multiplied by the plant-specific Cl₂ conversion in the boiler (for example, 3% of the total chlorine loading, that is to say 75% of in total 4%), and this value is then divided by the molar mass of Cl₂ (70.914 kg of Cl₂/kmol) and finally multiplied by the molar mass of sulfur dioxide (64.06 kg of S/kmol). This calculated chlorine-specific SO₂ consumption in the boiler must then be added to the residual SO₂ requirement corresponding to the total chlorine loading according to the sulfur addition ramp. Finally, the SO₂ consumption due to the known unavoidable SO₂/SO₃ conversion must further be taken into account. In waste incineration plants below 11% by volume oxygen, the SO₂ consumption is approximately 8% of the total SO₂ loading. Therefore, the previously determined SO₂ content in the flue gas upstream of the boiler must further be increased by the corresponding factor 1+0.08/0.92=1.09. The set-point SO₂ content thus calculated in the flue gas upstream of the boiler or the corresponding sulfur flow rate by mass is sufficient both for the partial suppression of free chlorine internal to the boiler and for the hypochlorite reduction in the circulating water of the alkaline scrubber.

A corresponding procedure can be followed for bromine. In this case the flue-gas-side total bromine loading or the waste water-side bromine loading is multiplied by the plant-specific proportion of intermediate free bromine determined for the case bromine. This proportion, according to our operational studies, is between 40% at low total bromine loadings up to 65% at high total bromine loadings and is therefore much greater than in the case of chlorine. In contrast to the free chlorine, the free bromine reacts substantially with SO₂ while still in the boiler (presumably to form SO₂Br₂), more precisely >90% of the free bromine. To an approximation, a 100% Br₂ conversion is assumed in the boiler. For the purpose of calculation, therefore, the total intermediate Br₂ loading is divided by the molar mass of Br₂ (159.88 kg of Br₂/kmol) and multiplied by the molar mass of sulfur dioxide (64.06 kg of SO₂/kmol). With an appropriate increase by the factor 1.09, in this case also, as described above, the sulfur consumption resulting from the oxidated SO₂/SO₃ conversion is also taken into account.

The alternative procedure described here of control using a running calculated theoretical SO₂ content in the flue gas upstream of the boiler as “acquired set-point value” of a primary control circuit is always of interest if the reducing agent required in the alkaline scrubber for the hypohalite reduction is not intended to be covered by the residual SO₂ from the dirty boiler gas upstream of the quench but instead by an externally fed reducing agent more stable to oxidation such as thiosulfate. Here, the sulfur addition ramp is set to values just above zero (“no requirement for residual SO₂ as reducing agent”). The added sulfur therefore serves only for the internal halogen consumption in the boiler, and instead of the residual SO₂ from the dirty boiler gas, for example, externally fed thiosulfate forms the reducing agent.

Free chlorine or bromine passing through into the clean gas in the event of SO₂ deficit is measured by direct measurement of the Cl₂ or Br₂ content in the clean gas downstream of the alkaline scrubber (for example, downstream of a fan, but certainly upstream of any downstream SCR catalyst bed), preferably using an electrochemical measuring cell like the Chemosensor from Dräger Sicherheitstechnik. See Dräger Sicherheits-technik: Product specification for DrägerSensor Cl₂-68 09 725. The test gas is continuously taken off from the flue gas duct in the bypass, dried, and then analyzed in the Chemosensor. Free chlorine (or free bromine) produces a change in voltage in the measuring cell of the Chemosensor that is converted to a concentration. Because of the high cross-sensitivity of the sensor to nitrogen oxide (NOₓ) also present in the clean gas upstream of the SCR, the primary Cl₂ measured values, at any rate, must be continuously corrected with regard to the apparent reading of CO₂ due to NOₓ using the current NOₓ content of the clean gas.

Alternatively, to monitor the Cl₂ or Br₂ content in the clean gas, instead of, or in addition to, the electrochemical measuring cell, however, a different continuously displaying Cl₂ and/or Br₂ measuring instrument could be positioned downstream of the flue gas scrubber (for example after the fan, but certainly still upstream of any downstream SCR catalyst bed), for example, an instrument based on near infrared spectrometry.

For chlorine, breakthrough free halogens in the clean gas must be measured upstream of the SCR catalyst bed, since the free chlorine, on passage of clean gas through the SCR, is demonstrably substantially back-reacted to HCl in accordance with the chlorine Deacon reaction catalyzed at the SCR catalyst under the clean gas conditions present there (low residual chlorine loading, high steam content, approximately 300° C.). However, this does not apply to free bromine (bromine Deacon reaction) and free iodine (iodine Deacon reaction).

Further monitoring of the adequacy of SO₂ provision would also be possible, for example, by measuring the hypohalite content in the alkaline scrubber wastewater.

In the event of an abrupt increase in the throughput of highly halogenated wastes, the halide loading in the waste water of the acidic scrubber follows the current total halogen loading in the flue gas in a delayed manner, as explained, due to the residence time of the acidic waste water in the acidic scrubber circuit/scrubber bottom phase.

In the case of such abrupt increases in loading, the set-point SO₂ content (whether this be the set-point SO₂ content in the flue gas upstream of the boiler acquired by calculation or the set-point residual SO₂ content in the dirty boiler gas upstream of the quench acquired directly by conductivity measurement and waste water metering), despite the intervention of the controller via the primary control circuit, is not adapted sufficiently quickly to the current total halogen loading, so that in the interim an SO₂ deficit occurs and therefore unwanted breakthrough of, for example, free Cl₂ or Br₂ into the clean gas downstream of the alkaline scrubber can occur.

In order to avoid completely breakthroughs due to rapid increases in loading, the added amount of sulfur must be increased promptly and in the interim oversupplied, for example, by 5 to 100% (preferably by 10 to 50%) until the amount of sulfur required by the primary control circuit again is alone sufficient for the X₂ suppression and NaOX reduction.

To implement this increase, the set-point residual SO₂ content in the dirty boiler gas upstream of the quench is increased via an “expanded control circuit” by up to 1000 mg SO₂/m³ (STP)_{dry}, for example, for chlorine from a Cl₂ content in the clean gas >0.5 mg of Cl₂/m³ (STP)_{dry} and increasingly with the level of Cl₂ content measured in the clean gas. This ensures that even in the event of an abrupt increase in chlorine loading in the dirty boiler gas upstream of the quench, a sufficient SO₂ excess is always present.

Alternatively, the sulfur rate can also be increased at the corresponding first increase in halide loading in the acidic waste water (as an index of an abrupt increase in total halogen loading taking place), preferably in proportion to the observed rate of increase in conductivity.

Both measures—both the possible intervention based on the concentration of free halogen in the clean gas downstream of the flue gas scrubber and the possible intervention based on rapid increase in halide loading in the acidic waste water—can be used together or separately in the “extended control circuit”.

The inventive process for controlled suppression of free halogens can also be used correspondingly with batchwise delivery of waste (“package procedure”). Here, the addition of sulfur and/or other sulfur carriers must be coupled to the package feed, that is to say to be increased periodically, more precisely, depending on the halogen or halide content of the package, with respect to the level, timepoint, and duration of the associated sulfur addition burst.

The addition of sulfur and/or other sulfur carriers that is bound to the feed cycle and matched to the package size with respect to level, timepoint, and duration can make use of automatically read-in individual barcodes on heating value, type of halogen, and amount of halogen in the individual package.

If sulfur granules are added, the addition apparatus is, in this case also, preferably a metering screw with subsequent pneumatic transport section to the primary combustion chamber.

If waste sulfuric acid is added, the apparatus for adding the sulfur is preferably a metering pump with subsequent nozzle or nozzle connection by which the material is injected atomized into the primary or secondary combustion chamber.

The inventive process has the advantage that via the controlled addition of sulfur or other sulfur carriers into the combustion chamber equally at two points of the combustion plant, free halogen such as Cl₂ and/or Br₂ are eliminated, more precisely first as early as in the waste-heat boiler (direct-gas phase reaction with SO₂), and second in the alkaline scrubber (hypohalite reduction with bisulfide formed from chemisorbed residual SO₂). The controlled addition of sulfur in proportion to the varying total halogen loading (primary control circuit) and the feed-forward control with interim exceedance of the sulfur rate on breakthrough of free halogens into the clean gas (extended control circuit with feed-forward control) ensures that, first, the minimum sulfur requirement is covered, but, second, that the acidic and alkaline scrubbers are not unnecessarily loaded with oxidized sulfur compounds such as SO₃SO₄²⁻ (acidic scrubber) or SO₂ (alkaline scrubber). Therefore, there is no unnecessarily high sulfur consumption and therefore also no unnecessarily high alkali consumption, either in the alkaline scrubber (NaOH consumption) or in a downstream wastewater treatment/heavy metal precipitation (for example Ca(OH)₂ consumption), and thus, finally, also no unnecessarily high production of residues to be landfilled, for example, calcium sulfate dihydrate CaSO₄.2H₂O.

The following examples further illustrate details for the process of this invention. The invention, which is set forth in the foregoing disclosure, is not to be limited either in spirit or scope by these examples. Those skilled in the art will readily understand that known variations of the conditions of the following procedures can be used. Unless otherwise noted, all temperatures are degrees Celsius and all percentages are percentages by weight.

### EXAMPLES

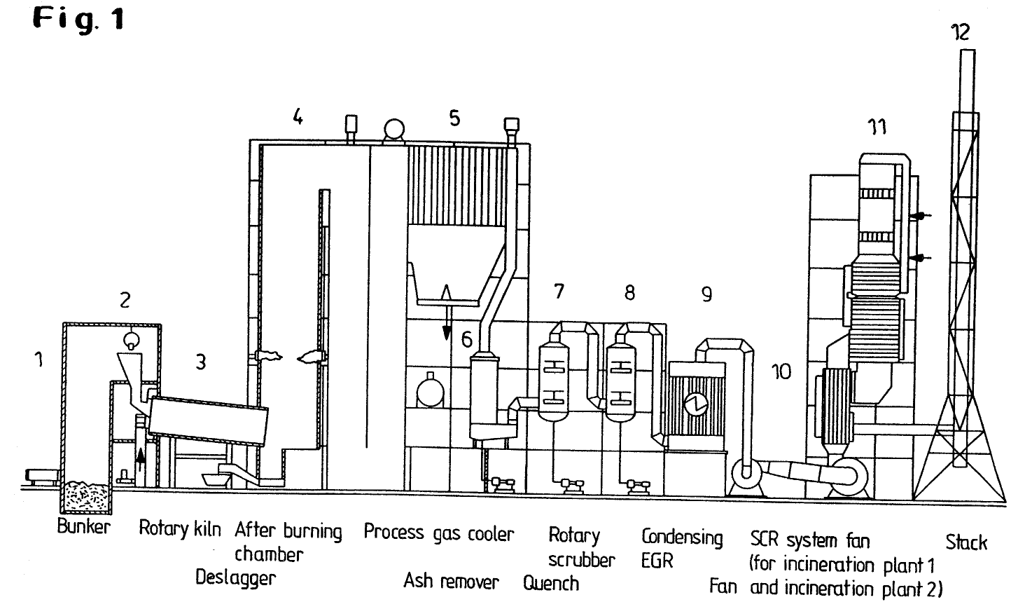

FIG. 1 shows a typical waste incineration plant (here the special waste incineration plant VA1 in the Bayer Leverkusen-Bürrig disposal center) having feed equipment for solid waste and packages 1 and for liquid waste 2, the rotary kiln 3, the afterburning chamber 4, the waste-heat boiler 5, the quench 6, the acidic rotary atomizing scrubber 7, the alkaline rotary atomizing scrubber 8, the condensation EGR 9, fans 10, a downstream SCR denitration unit 11, and the stack 12.

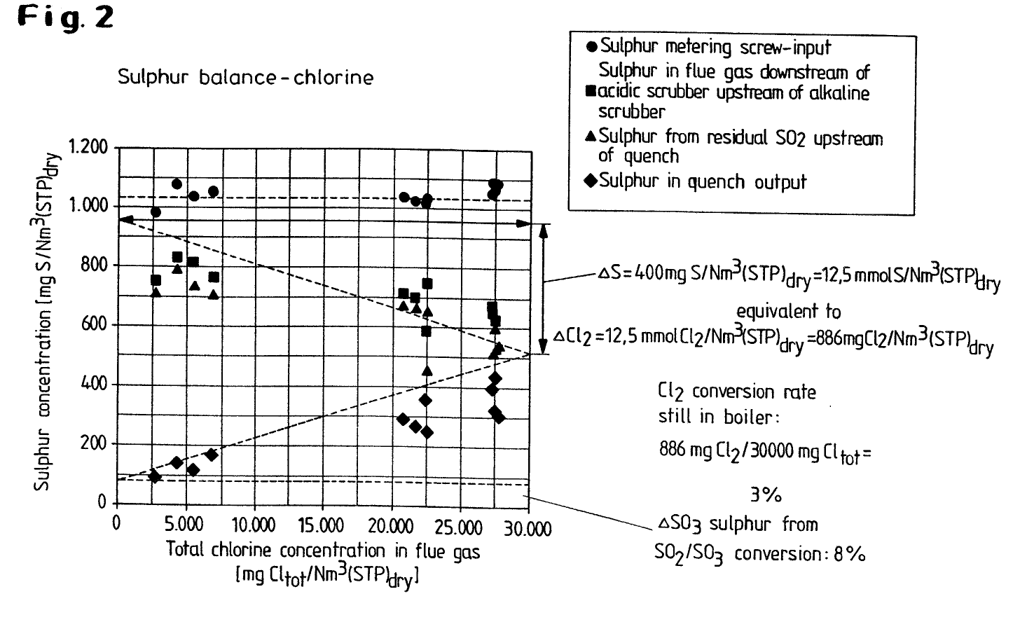

FIG. 2 shows by way of example for chlorine (that is to say the incineration of highly chlorinated waste) a “closed sulfur balance covering a furnace, boiler, and acidic scrubber”. This diagram demonstrates that in the boiler approximately 3% of the total chlorine loading back-reacts as intermediate Cl₂ still in the boiler, with SO₂, to reform HCl and SO₃. The resultant SO₃ is recovered in the acidic quench waste water as SO₄²⁻. The operational experiments for FIG. 2 were carried out at a constant high sulfur supply with a total chlorine loading increasing stepwise. The x axis of the diagram is the total chlorine loading, based on the dry flue gas volumetric flow rate, and therefore described as mg of Clₜₒₜ/m³ (STP)_{dry}. The y axis of the diagram is the “sulfur flow rate by mass” present in the flue gas-side SO₂ and in the waste water-side SO₄²⁻, in each case also based on the dry flue gas volumetric flow rate of approximately 40,000 m³(STP)_{dry}/h at the plant studied here (mg of S/m³(STP_{dry}). FIG. 2 also shows some measured SO₂ values downstream of the acidic scrubber, that is to say in the acid-scrubbed clean gas upstream of the alkaline scrubber in order to verify that the dirty gas-side SO₂ (downstream of the boiler/upstream of the quench) as expected passes through the acidic scrubber region.

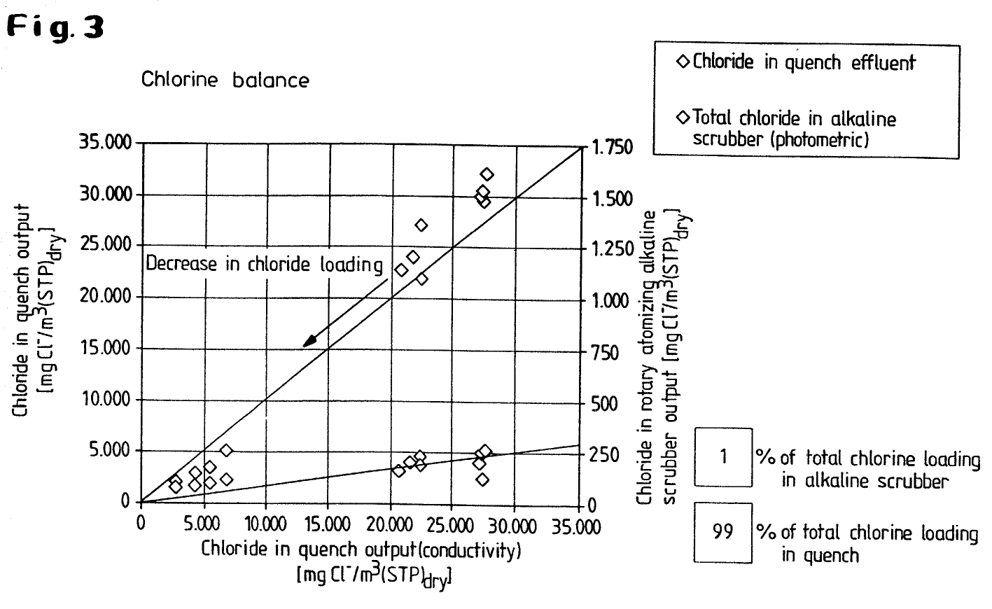

FIG. 3 shows the associated chlorine balance, at this point including the alkaline scrubber (alkaline rotary atomizing scrubber), in order to verify by way of example that, when the sulfur supply is sufficient, 99% of the total chlorine loading passes as HCl into the acidic scrubber and only 1% of the total chlorine loading passes as Cl₂ into the alkaline scrubber and is finally reduced there to stable chloride (via the residual SO₂ in the dirty boiler gas upstream of the quench).

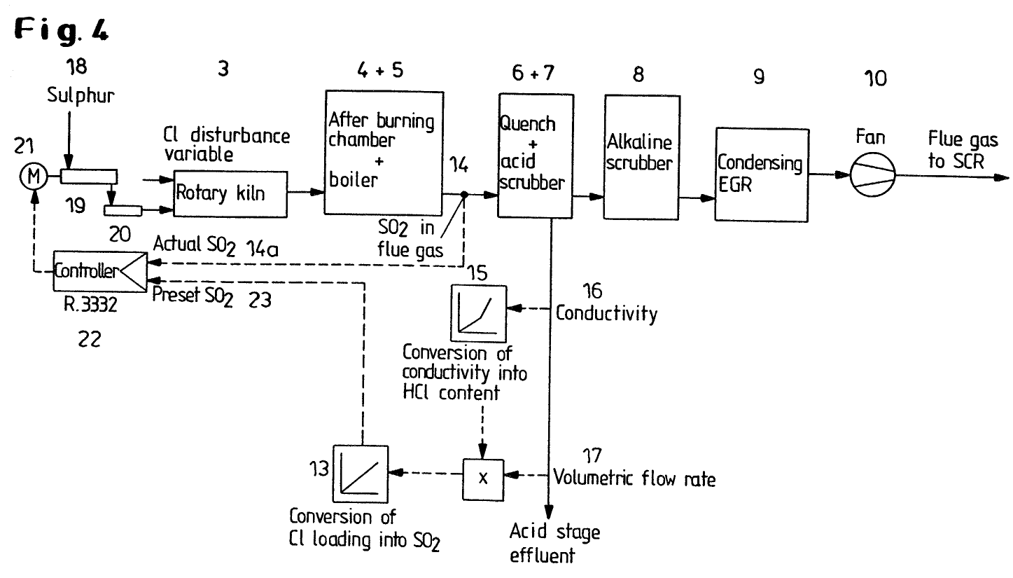

FIG. 4 shows by way of example for chlorine the primary control circuit using the chlorine-specific sulfur addition ramp 13 with acquisition of the residual SO₂ set-point value 14a in the dirty boiler gas 14 upstream of the quench based on the halide loading in the quench waste water. The latter is determined from the HCl content 15 in the waste water (determined on the basis of temperature-compensated conductivity measurement 16) by multiplication with the waste water volumetric flow rate 17 (magnetic inductive flow meter measurement). The required rate by mass of sulfur granules 18 is added to the top of the primary combustion chamber (rotary kiln) 3 via the metering screw 19 and pneumatic transport line 20. The controlled variable here is the rotary speed of the metering screw drive 21. This rotary speed is changed via the P-I controller R.3332 22. This controller 22 continuously matches the actual residual SO₂ value 14a measured downstream of the waste-heat boiler 5 with the set-point residual SO₂ value 23 required according to the sulfur addition ramp 13.

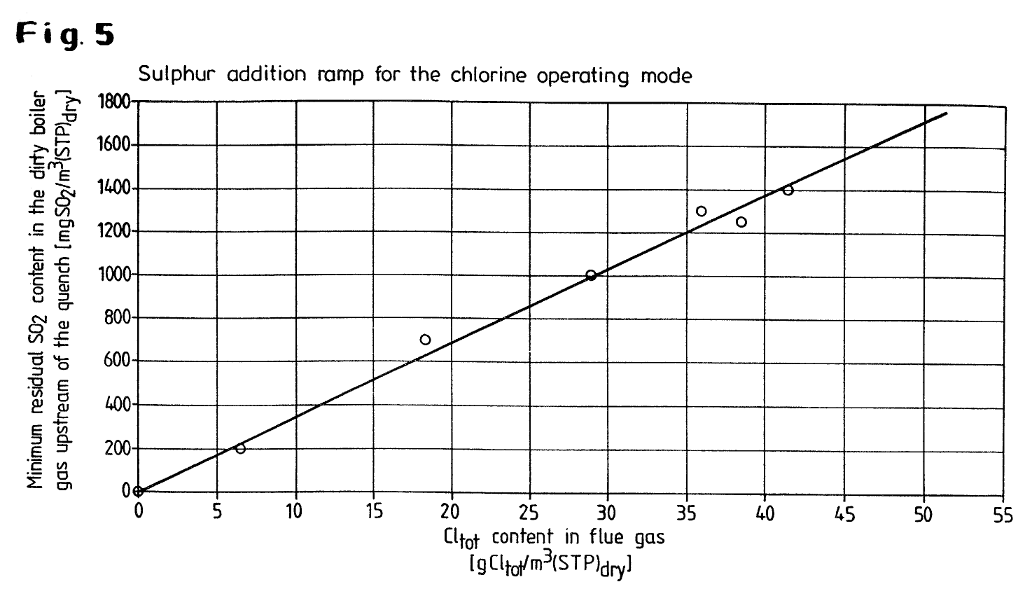

FIG. 5 shows, again by way of example for chlorine, the chlorine-specific sulfur addition ramp used in the primary control circuit (FIG. 4) and determined in advance operationally. For its determination 6 combustion experiments were carried out at different total loadings. The main parameters of these operational experiments are given in Table 1. For each of the operational experiments, the throughput of a highly chlorinated liquid waste mixture of dichloropropane, DCP, and chlorinated hydrocarbon (each of known chlorine content) was kept constant. The respective chlorine loading (based on the dry flue gas volumetric flow rate of approximately 40,000 m³ (STP)_{dry}/h) may be read off on the x axis of FIG. 5, whereas the y axis in FIG. 5 shows the required set-point residual SO₂ value (minimum residual SO₂ contents) in the dirty boiler gas upstream of the quench, based on the dry flue gas volumetric flow rate.

TABLE 1
Main parameters of the 6 operational experiments for determining
the sulfur addition ramp in the case of chlorine (VA2 flue gas
volumetric flow rate approximately 40,000 m³(STP)_{dry}/h)

| | | Experiment No. | | | | | |
|---|---|---|---|---|---|---|---|
| | | 1 | 2 | 3 | 4 | 5 | 6 |
| Throughput DCP/ | kg/h | 600 | 1800 | 1400 | 3000 | 3000 | 3000 |
| chlorinated | | | | | | | |
| hydrocarbons | | | | | | | |
| Chlorine content¹ | % | 41.6 | 59 | 56 | 55.7 | 55 | 55 |
| Heating value | MJ/kg | 21 | 19.6 | 19 | 19.6 | 20 | 20 |
| Input Clₜₒₜ loading² | kg/h | 250 | 1062 | 826 | 1671 | 1650 | 1650 |
| Output chloride | kg/h | 250 | 1100 | 700 | 1400 | 1300 | 1500 |
| loading³ | | | | | | | |
| SO₂ in the dirty | mg/m³ | 600 | 1400 | 900 | 1700 | 1400 | 1400 |
| boiler gas at start | (STP)_{dry} | | | | | | |
| of experiment⁴ | | | | | | | |

¹Chlorine content according to laboratory analysis of the chlorinated hydrocarbon/DCP mixture used
²Determined via chlorine content and the flow rate of the mixture burnt
³In the quench effluent, that is to say determined via HCl concentration and effluent flow rate
⁴Set-point at the start of the experiment, estimated from preceding preliminary experiments

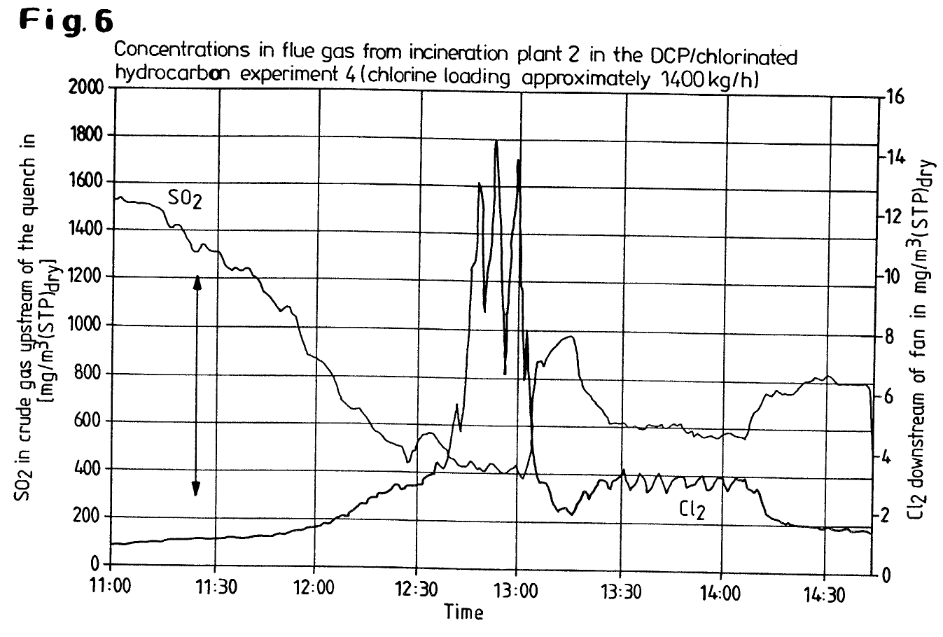

FIG. 6 (based on Experiment 4 in Table 1) documents by way of example the procedure for determining one point on the sulfur addition ramp. The diagram shows the contents of residual SO₂ in the dirty boiler gas (left y axis) and of the free chlorine in the clean gas downstream of the alkaline scrubber, measured downstream of the fan (right y axis) as a function of time of the experiment. A high residual SO₂ content was first preselected in the dirty boiler gas and this was then slowly decreased from the start of the experiment. From a residual SO₂ content of about 1400 mg of SO₂/m³(STP)_{dry} in the dirty boiler gas upstream of the quench, the Cl₂ concentration in the clean gas upstream of the SCR begins to increase slightly until, after 12:30, at about 500 mg of residual SO₂/m³(STP)_{dry}, a marked increase in free chlorine (Cl₂ breakthrough) occurs. The residual SO₂ content from which the Cl₂ concentration in the clean gas greatly increases and the associated Clₜₒₜ concentration in the flue gas (here, approximately 36 g of Clₜₒₜ/m³(STP)_{dry}) establish a point on the sulfur addition ramp. The further experiments verify that the sulfur addition ramp is in fact linear.

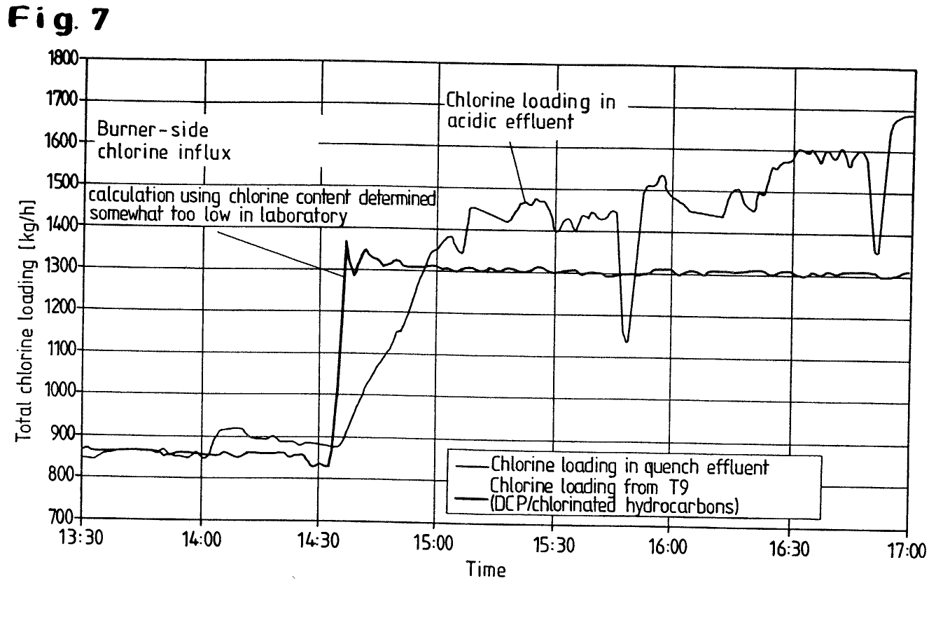

As FIG. 7 shows for a targeted abrupt increase in halogen throughput, again for chlorine, the halide loading determined indirectly via the acidic scrubber effluent follows the current total halogen loading in the flue gas with a delay caused by the size of the scrubber bottom phase.

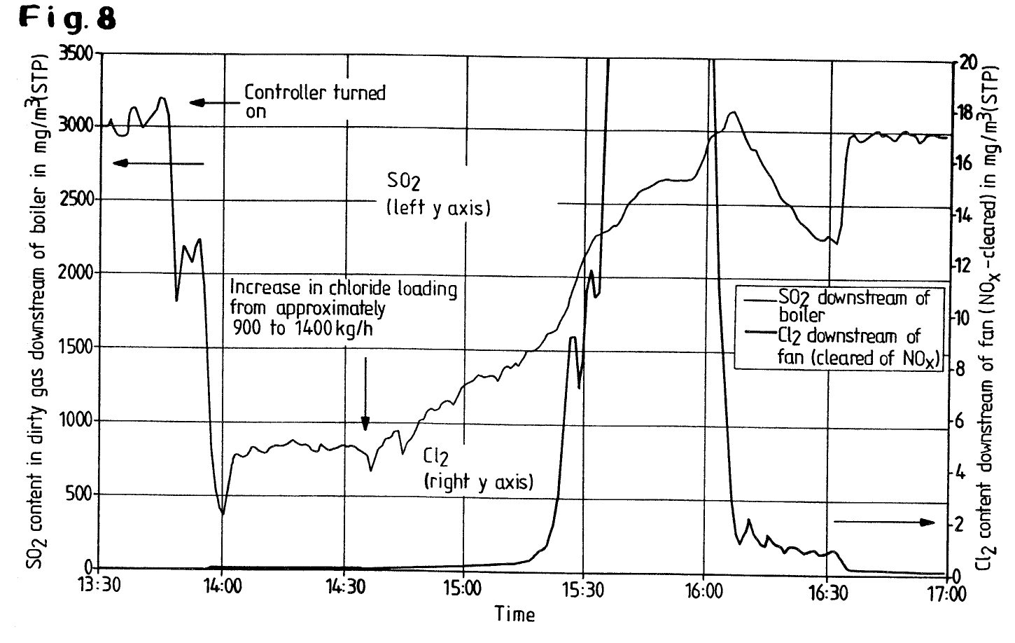

FIG. 8 shows the SO₂ deficit due to this delay in the event of an abrupt increase in loading following a lag in detection of the current total halogen loading and, with sole operation of the primary control circuit, the still observable CO₂ breakthrough into the clean gas downstream of the alkaline scrubber. After the primary control circuit is started up at 13:45, the primary control circuit controls the residual SO₂ content in the dirty boiler gas from the set-point value first to the value currently actually required according to the sulfur addition ramp. At 14:35, the chlorine loading was then abruptly increased in a targeted manner from 900 kg/h to 1400 kg/h (see FIG. 7). As a result of the delayed detection of the rapidly rising current total chlorine loading and thus delayed following of the residual SO₂ content, the Cl₂ concentration in the clean gas increases after 45 min (16:15) and finally to a “Cl₂ breakthrough” to values >>5 mg of Cl₂/m³(STP)_{dry} in the clean gas. When the residual SO₂ content finally reaches the required final value, the Cl₂ breakthrough is also ended.

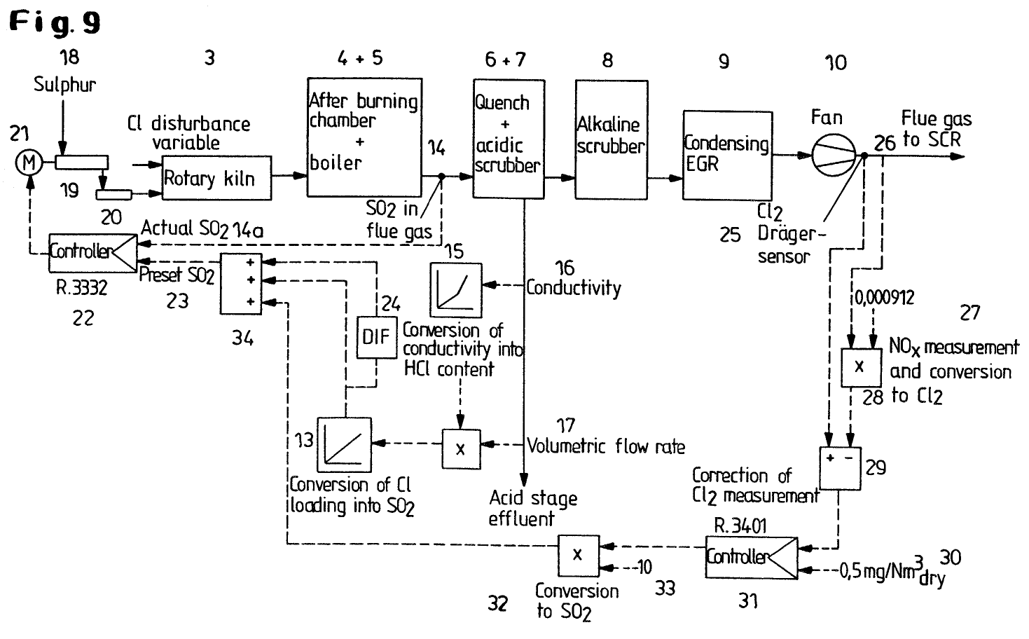

Such types of Cl₂ breakthrough may be prevented by the “control circuit with feed-forward control” that is shown in FIG. 9 and is extended compared with the primary control circuit. In accordance with the extended control concept, the residual SO₂ set-point value 14a in the dirty boiler gas 14 upstream of the quench is not led solely via the sulfur addition ramp 13 in accordance with the lagging chloride loading of the acidic waste water and thus the amount of sulfur added 18 is gradually increased. Rather, the residual SO₂ set-point value 14a in the dirty boiler gas 14 upstream of the quench is in the interim taken to excess in a targeted manner, as soon as increased free chlorine can be measured in the clean gas downstream of the alkaline scrubber 8/downstream of the fan 10 (but, note, still upstream of the following SCR catalyst bed). For this measurement of free chlorine, a Chemosensor 25 from Dräger Sicherheitstechnik is preferably used. The test gas is continuously taken off from the flue gas duct, dried and analyzed. The free chlorine induces in the Chemosensor 25 measuring cell a change in voltage which is converted to a concentration. Because of the high cross sensitivity of the sensor 25 to NOₓ 26 still also present in the clean gas upstream of the SCR, the primary Cl₂ measurements from the sensor 25 are corrected for the apparent reading due to NOₓ using instrument-specific correction factors 27 (calculation of the apparent reading 28, subtraction of the apparent reading from the primary Cl₂ measurement 29).

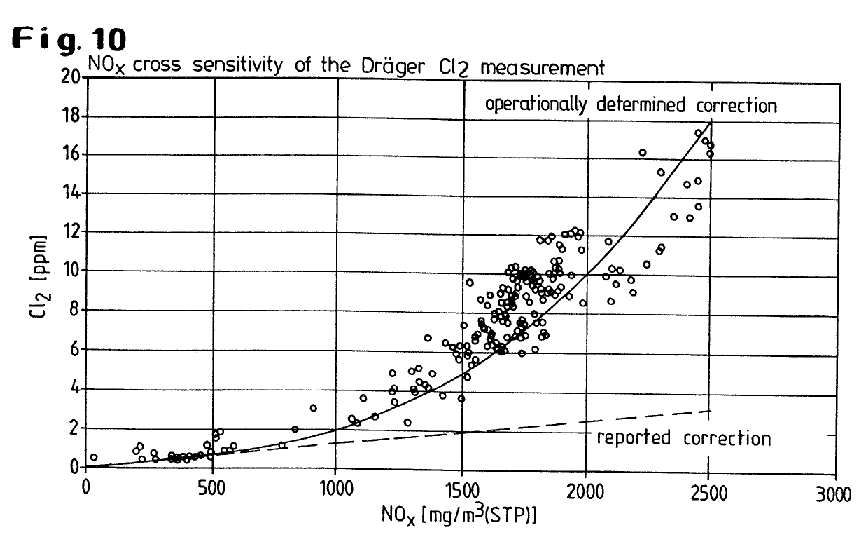

The apparent chlorine reading ΔCl₂ (28) due to NOₓ cross sensitivity of the Dräger measuring cell installed 25 follows a simple instrument-specific correction equation, for example, in the form ΔCl₂/ppm=a*NOₓ/(mg/m³(STP)_{dry}). In the event of occasionally high NOₓ contents in the clean gas upstream of the SCR it is advisable, in view of the low limiting value for Cl₂, to use a correction equation in the form ΔCl₂/ppm=a′*[(NOₓ/(mg/m³(STP)_{dry}))²−b′*NOₓ/(mg/m³(STP)_{dry})] and to verify the coefficients a′ and b′ of this correction equation by appropriate operational measurements. This can be performed directly, for example, with operational flue gas with NOₓ-rich but chlorine-free procedure (measurement results in FIG. 10).

As FIG. 9 further shows, the NOₓ-corrected Cl₂ measurement, from a set-pointable CO₂ content 30 in the clean gas of, for example, 0.5 mg Cl₂/m³(STP)_{dry}, is converted by the controller R.3401 31 into an additional SO₂ requirement that can be increased in the amplifier 32 again by a set-pointable amplification factor 33, for example, the factor 10. This additional SO₂ requirement is added in the “disturbance variable addition instrument” 34 to the SO₂ requirement on the part of the primary control circuit. Thus the SO₂ set-point value 23 increases by, for example, 1000 mg of SO₂ m³(STP)_{dry}. The controller 22 continuously matches the actual residual SO₂ value 14a measured downstream of the waste-heat boiler 5 to the residual SO₂ set-point value 23 increased in accordance with the feed-forward control described.

This ensures that in the event of an abrupt increase in chlorine loading a sufficiently large SO₂ supply is always present.

As a redundant safety measure against Cl₂ breakthroughs, the increase with time in chloride loading in the quench waste water can also be included in the data analysis, for example via a differentiating controller module DIF (differentiation of the increase with time 24), in order, in case of a rapid increase, to be able to increase immediately the residual SO₂ set-point value 23 from here also.

All measures for the interim increase in residual SO₂ set-point value 23 above the residual SO₂ set-point value solely demanded by the lagging sulfur addition ramp 13 can be used together (addition in disturbance variable addition instrument 34) or separately.

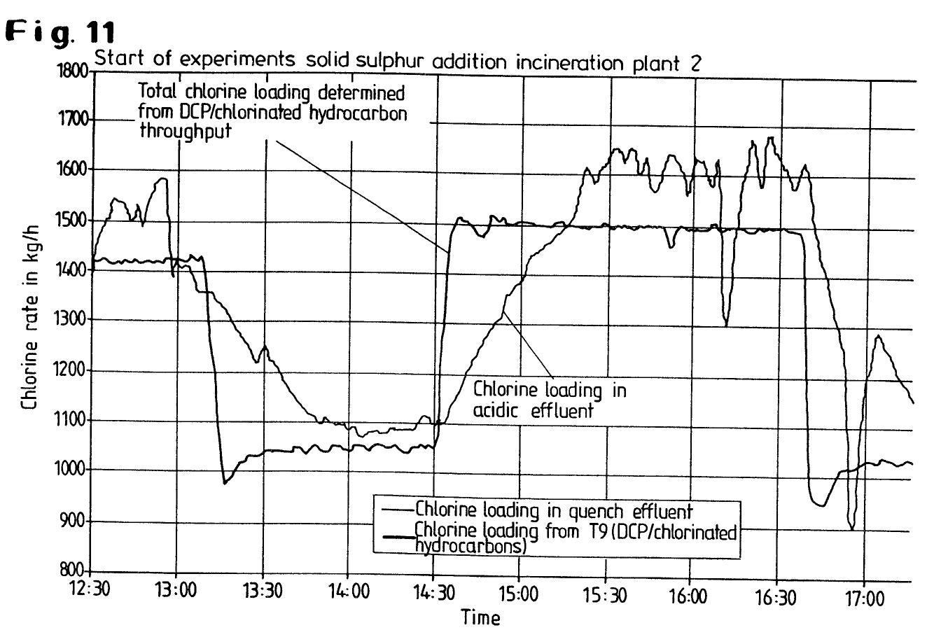

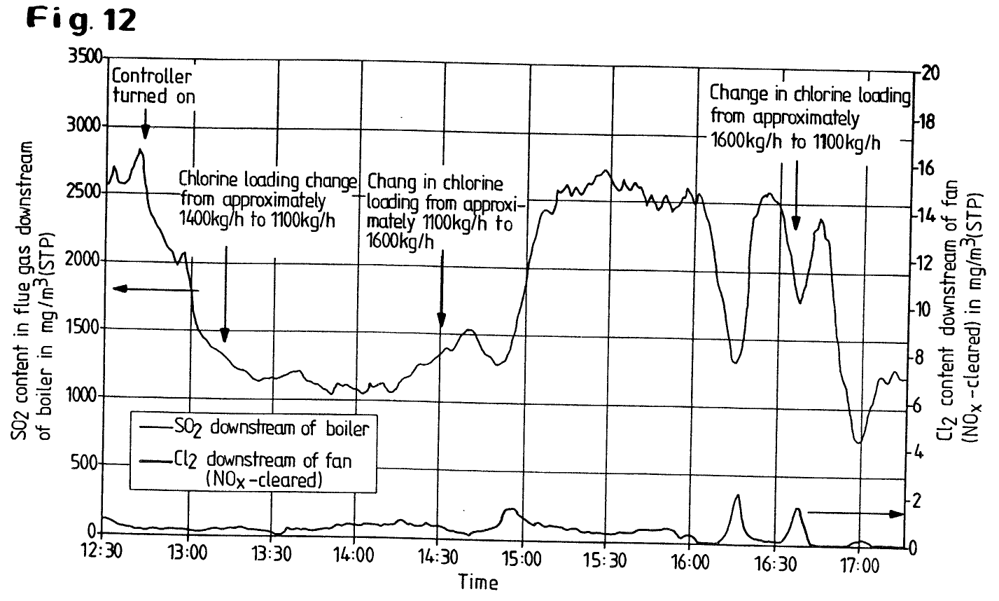

In order to demonstrate the action of the extended control circuit with feed-forward control, in a further operational experiment, further large jumps in total chlorine loading were specifically induced. See FIG. 11. Despite the great and rapid changes in loading indicated in FIG. 11, the extended control circuit (FIG. 9) gave the outstanding result shown in FIG. 12: on switching on the extended control circuit at 12:40, the residual SO₂ content first falls to the value corresponding to the total chlorine loading in accordance with the sulfur addition ramp of approximately 1200 mg of SO₂/m³(STP)_{dry}. After the decrease in chlorine loading from 1500 kg/h to 1 100 kg/h at 13:10, the residual SO₂ content in the dirty boiler gas decreases further. At 14:30, the chlorine loading is then abruptly increased. Due to the occurrence of free chlorine >0.5 mg/m³(STP)_{dry} in the clean gas, there is then performed, via the controller R.3401 (see FIG. 9), a leading rise in the residual SO₂ set-point value and thus prompt increase in the actual residual SO₂ content in the dirty boiler gas upstream of the quench by approximately 1000 mg of SO₂/m³(STP)_{dry}. Accordingly, no Cl₂ breakthrough occurs, but rather the Cl₂ content in the clean gas decreases back to values <0.5 mg/m³(STP)_{dry}. Note that at 16:10, because there was a brief fault in the sulfur metering screw, the residual SO₂ content fell briefly to a low level so that in the clean gas again a small peak of free chlorine occurred (16:15). As a response of the extended control circuit to comparable large increases in loading, as before, therefore, in contrast to the primary control circuit (see FIG. 4) alone, only extremely small Cl₂ peaks are observed in the concentration range <<5 mg of Cl₂/m³(STP)_{dry}.

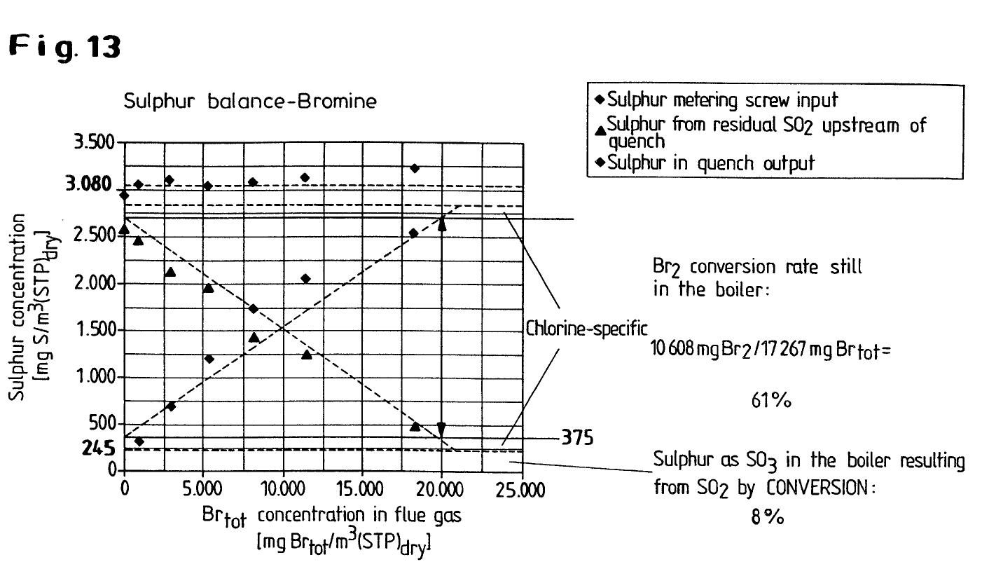

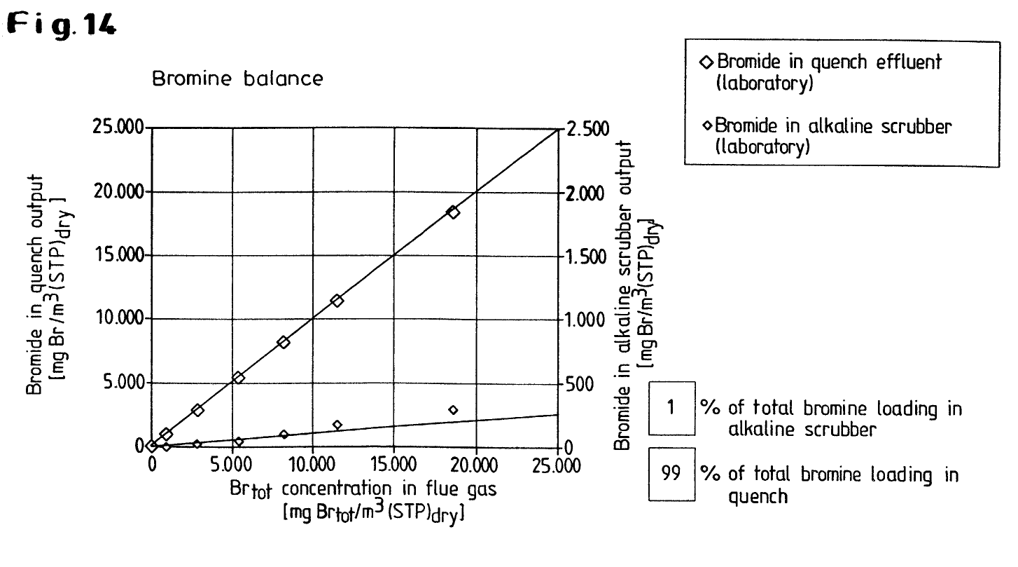

The examples described above are essentially restricted to the combustion of chlorine-containing wastes. However, as the closed sulfur balance for bromine in FIG. 13 and the bromine balance in FIG. 14 verify, the basic relationships previously determined for the example of chlorine also relate to the other halogens, such as bromine considered here as a further example, although much higher contents of free halogens are involved.

Similarly to FIG. 2 for chlorine, FIG. 13 for bromine shows that in the boiler, a mean Br₂ proportion of approximately 61% of the total bromine loading is converted (instead of 3% in the case of chlorine). Note that the high-bromine liquid waste burned in the experiment comprised, in addition to 25% bromine, also approximately 3% chlorine. This chlorine is taken into account in FIG. 13, that is to say the result of the evaluation shown is “cleared of chlorine”.

In a similar manner to FIG. 3 for chlorine, FIG. 14 for bromine shows that here also only approximately 1% of the total loading passes into the alkaline scrubber. That is to say, despite the significantly higher proportion of free bromine of the total bromine loading, if there is an adequate sulfur supply, here also 99% of the total bromine loading is removed in the acidic scrubber.

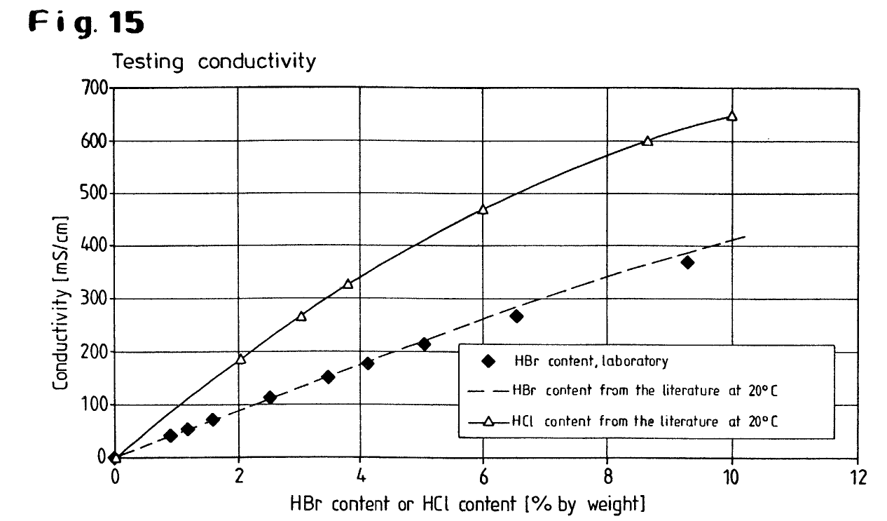

FIG. 15 shows the comparison of conductivity (temperature-compensated to 20° C.) of aqueous HCl and HBr solutions. At the same conductivity the content of bromide by mass compared with the content of chloride by mass, according to the molar mass ratio HBr/HCl=80.948/36.465=2.22, is somewhat more than twice as high.

Many highly chlorinated liquid wastes contain no bromine or only a little bromine. Most highly brominated liquid wastes, in contrast, contain, in addition to bromine, also a significant amount of chlorine. On evaluating the conductivity measurements, for such bromine-rich and simultaneously chlorine-rich wastes, it is possible, without making any significant error in the later calculation of sulfur requirement, to proceed from bromine (as main halogen) alone, for example, that is to say to use only the conductivity curve of aqueous bromide solutions as a basis, provided that, in the subsequent calculation of the sulfur requirement, again only bromide is used as a basis (that is to say the associated molar mass of HBr is used). In this manner, when evaluating the conductivity measurements, instead of the amount of chloride also present, an “equivalent amount of bromide” is determined with respect to sulfur requirement.

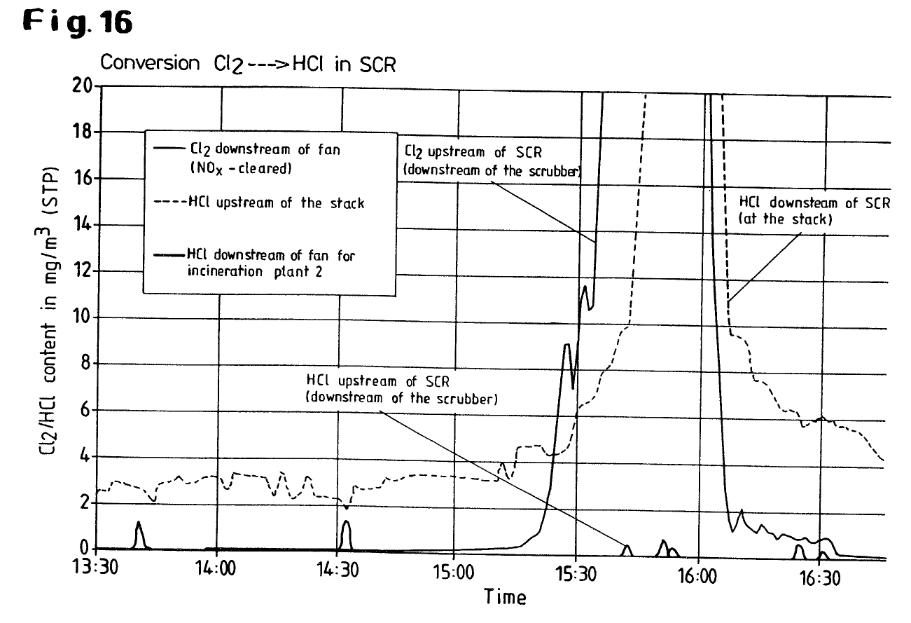

Finally, FIG. 16 verifies the above repeatedly described fact that the free chlorine, on passage of clean gas through a downstream clean gas SCR substantially back-reacts to HCl under the clean gas conditions present there (low residual chlorine loading, high steam content, approximately 300° C.) in accordance with the chlorine-Deacon reaction catalysed in the presence of metal oxide-rich SCR catalysts.

What is claimed is:

1. A process for low-corrosion and low-emission co-incineration of highly halogenated liquid wastes comprising co-incinerating a highly halogenated liquid waste in a waste incineration plant having at least one combustion chamber, a waste-heat boiler, and a multistage flue gas scrubber comprising an acidic scrubber and alkaline scrubber, wherein sulfur or a sulfur carrier is added to the combustion chamber by controlled addition in an amount substantially in proportion to the halogen loading.

2. A process according to claim 1 wherein the amount of sulfur is added under control in proportion to the current loading of chlorine, bromine, or iodine in the waste.

3. A process according to claim 1 wherein the amount of sulfur is added in accordance with an operationally determined sulfur addition ramp that stipulates the residual SO₂ content in the dirty gas downstream of the boiler and upstream of the quench that is required at the current halogen loading for the high-halogen wastes.

4. A process according to claim 1 wherein a linear sulfur addition ramp is determined operationally in each case for high-halogen wastes by determining for at least one greater halogen loading in the waste the minimally required SO₂ content in the dirty boiler gas at which, in steady state operations, no free halogen or only an amount of free halogen below a set-point limiting value can be detected in the clean gas downstream of the flue gas scrubber.

5. A process according to claim 1 wherein the current flue gas-side halogen loading is continuously determined approximately as halide loading in the acidic flue gas scrubber effluent, determined as the product of halide concentration and effluent volumetric flow rate.

6. A process according to claim 1 wherein current flue gas-side halogen loading is continuously determined by measuring halogen and hydrogen halide species in the dirty boiler gas upstream of the quench and downstream of the boiler and the dry flue gas volumetric flow rate or a parameter proportional to the flue gas volumetric flow rate.

7. A process according to claim 1 wherein the amount of sulfur that corresponds to the halogen loading in the flue gas or the halide loading in the acidic scrubber effluent in accordance with the sulfur addition ramp is briefly elevated by 5 to 100% as soon as free halogen is measured in the clean gas downstream of the flue gas scrubber but still upstream of any following SCR catalyst bed.

8. A process according to claim 1 wherein the amount of sulfur that corresponds to the halogen loading in the flue gas or the halide loading in the acidic scrubber effluent in accordance with the sulfur addition ramp is briefly increased by 5 to 100% as soon as a rapid increase in halide concentration in the acidic scrubber effluent is measured.

9. A process according to claim 1 wherein the sulfur is added in the form of solid sulfur, liquid sulfur, or waste sulfuric acid.

10. A process according to claim 1 wherein solid sulfur is added in pelleted or granulated form via controllable metering elements.

11. A process according to claim 1 wherein solid sulfur is fed into the primary combustion chamber by pneumatic transport.

12. A process according to Clam 1 wherein waste sulfuric acid is added to the primary or secondary combustion chamber via controllable metering pumps.

13. A process according to claim 1 wherein waste sulfuric acid is fed into the primary or secondary combustion chamber via an atomizer nozzle or corresponding jet assemblies.

14. A process according to claim 1 wherein for a periodically changing halogen loading in the flue gas that results from a timed feed of high-halogen individual packages, the sulfur and/or other sulfur carrier is added in an amount that is coupled to the timing of the feed and matched to the size of the packages with respect to height, timepoint, and time period.

15. A process according to claim 14 wherein the addition of sulfur and/or other sulfur carrier that is coupled to the timing of the feed and matched to the size of the packages with respect to height, timepoint, and time period, is carried out using automatically read-in individual bar codes for the heating value, type of halogen, and amount of halogen of the packages.

16. A process according to claim 1 wherein hypohalite reduction in the alkaline scrubber proceeds via the bisulfide that forms internally in the process from the residual SO₂ of the dirty boiler gas and at the same time or alone via an externally added reducing agent.

17. A process according to claim 3 wherein a sulfur addition ramp that is determined operationally for a pure chlorine-containing waste is also used for the combustion of halogen mixtures that, in addition to chlorine, comprise other halogens.

18. A waste incineration plant having a combustion chamber, a waste-heat boiler, a multistage flue gas scrubber comprising an acidic scrubber and an alkaline scrubber, wherein the waste incineration plant has one or more control devices for the controlled addition of sulfur and/or other sulfur carriers into a primary or secondary combustion chamber.

19. A waste incineration plant according to claim 18 having one or more metering systems and one or more transport systems for the controlled addition of sulfur or other sulfur carriers into the primary or secondary combustion chamber.

20. A waste incineration plant according to claim 19 wherein the system for the controlled addition of sulfur or other sulfur carriers is a controllable transport system.

21. A waste incineration plant according to claim 20 wherein the system for the controlled addition of waste sulfuric acid is a controllable metering pump and the waste sulfuric acid is injected via a nozzle and/or a jet assembly into the primary or secondary combustion chamber.

22. A waste incineration plant according to claim 18 wherein at least one control device has a primary control circuit having set-point value control of the continuously measured residual SO₂ content in the dirty boiler gas upstream of the quench or, in a corresponding extended control circuit, has an additional feed-forward control in which the primary control circuit controls the sulfur addition according to a sulfur addition ramp in proportion to the current halogen loading in the flue gas or to the halide loading in the acidic effluent.

23. A waste incineration plant according to claim 19 wherein at least one control device has a primary control circuit having set-point value control of the SO₂ content in the flue gas upstream of the boiler calculated on-line or, in a corresponding extended control circuit, has additional feed-forward control in which the primary control circuit controls the sulfur addition on the basis of a continuous halogen-specific conversionary calculation via the speed of rotation of the metering system taking into account the transport characteristic of the metering system in proportion to the current halogen loading in the flue gas or to the halide loading in the acidic effluent.

24. A waste incineration plant according to claim 22 wherein the corresponding extended control circuit, at the start of Cl₂ breakthrough into the clean gas and/or in the event of a rapid increase in halide content in the acidic effluent, temporarily elevates the sulfur addition by feed-forward control.

25. A waste incineration plant according to claim 23 wherein the corresponding extended control circuit, at the start of Cl₂ breakthrough into the clean gas and/or in the event of a rapid increase in halide content in the acidic effluent, temporarily elevates the sulfur addition by feed-forward control.

26. A waste incineration plant according to claim 22 wherein the control circuit is a linear sulfur addition ramp that is determined operationally in each case for high-halogen wastes by determining for at least one greater halogen loading in the waste the minimally required SO₂ content in the dirty boiler gas at which, in steady state operations, no free halogen or only an amount of free halogen below a set-point limiting value can be detected in the clean gas downstream of the flue gas scrubber.

27. A waste incineration plant according to claim 22 wherein the current halogen loading is continuously determined approximately as halide loading in the acidic flue gas scrubber effluent, determined as the product of halide concentration and effluent volumetric flow rate.

28. A waste incineration plant according to claim 22 wherein the current halogen loading is continuously determined by measuring halogen and hydrogen halide species in the dirty boiler gas upstream of the quench and downstream of the boiler and the dry flue gas volumetric flow rate or a parameter proportional to the flue gas volumetric flow rate.
